(19) United States
(12) Patent Application Publication
(10) Pub. No.: US 2015/0004514 A1
(43) Pub. Date: Jan. 1, 2015

(54) METHOD FOR SUPPLYING AIR TO A FUEL CELL

(71) Applicant: Daimler AG, Stuttgart (DE)

(72) Inventors: Sven Schmalzriedt, Esslingen (DE); Jonas Hanschke, Tuebingen (DE)

(73) Assignee: DAIMLER AG, Stuttgart (DE)

(21) Appl. No.: 14/373,077

(22) PCT Filed: Dec. 22, 2012
(86) PCT No.: PCT/EP2012/005372

§ 371 Date: Jul. 18, 2014

(30) Foreign Application Priority Data
Jan. 24, 2012 (DE) 10 2012 001 298.5

(51) Int. Cl. H01M 8/04

(52) U.S. Cl. CPC H01M 8/04104; H01M 8/04313; H01M 2250/20
USPC 429/446

(57) ABSTRACT

A method for supplying air to a fuel cell (2) by means of a controllable air-conveying device that delivers an air mass flow for a cathode chamber (4) of the fuel cell (2). The air-conveying device (7) is adjusted to a specified value of a pressure (pₛₒₗₗ) in the air line and/or to a specified value of a pressure loss (Δpₛₒₗₗ) across a component of the air line.

The invention relates to a method for supplying air to a fuel cell according to the kind defined in greater detail in the preamble of claim 1. The invention further relates to the use of such a method.

Methods for supplying air to a fuel cell in a fuel cell system are known from the prior art. Typically, a controllable air-conveying device is used for this purpose which, for example, can be controlled in terms of its rotational speed so that thereby the required air volume or air mass for the fuel cell can be set. It is generally known and common in particular in vehicle applications of fuel cell systems to use an air mass flow sensor or air flow meter. Such air flow meters for vehicle applications are known from the prior art. Such an air flow meter can be used for adequately controlling the air mass flow in a closed loop system by means of the air supply device.

However, the air mass flow sensors known from the vehicle technology sector are typically configured for internal combustion engines. They are comparatively expensive and, due to the different requirements of an internal combustion engine and a fuel cell, they are not optimized for the purpose needed for supplying air to the fuel cell. Since the conditions for supplying air in a fuel cell system are different from those in an internal combustion engine, the result is high inaccuracy of the measurement and, as observed by the inventors, premature failure of the air mass flow sensors. This applies in particular in cases in which the additional necessity of operating a flow compressor as an air supply device not too close to its surge line requires in certain system architectures to measure the air mass flow needed for supplying the fuel cell not in the intake path, as this is common for internal combustion engines, but to measure it on the discharge side of the air-conveying device. Such a measurement on the discharge side of the air-conveying device poses a serious problem for conventional air mass flow sensors and has a particularly negative effect on their reliability, measuring accuracy and service life.

Furthermore, it is known from US 2011/0003223 A1 to control an air supply device of a fuel cell system depending on the load of the fuel cell system. The controllable air supply device is controlled here depending on the power generated by the fuel cell. This control, purely based on electrical variables, is principally simple. However, it results in significant inaccuracies since the flow conditions of the air, temperature, humidity and other variables influencing the air mass flow or the air volume flow are completely disregarded here.

It is therefore an object of the present invention to propose a method for supplying air to a fuel cell that avoids these disadvantages and to provide a control as accurate as possible for the air mass flow for the fuel cell by using a simple and cost-effective system.

According to the invention, this object is achieved by the features in the characterizing part of the claim 1. Advantageous configurations and refinements thereof arise from the remaining dependent sub-claims. Furthermore, a particularly preferred use of the method is specified in claim 9.

It is provided in the method according to the invention that the air-conveying device is adjusted to a specified value of a suitable pressure in the air section of the fuel cell and/or to a specified value of a pressure loss across a component of the air section.

In the method according to the invention, the complicated and expensive air mass flow sensor, which is very susceptible to failure when used in a fuel cell system, can be omitted. Nevertheless, via a measurement of the pressure or a pressure loss and, according to an advantageous refinement, via a correction of the setpoint value for the pressure or pressure loss with known measured variables, the method allows a very reliable determination of the air mass flow or of a value correlating therewith via measured values from simple, reliable and cost-effective sensors. Typically, the pressure sensors are already included in the fuel cell system so that the method can be carried out in a simple and efficient manner without additional constructional efforts in the region of the fuel cell system. The pressure or pressure loss can be measured at any place in the air section. The method according to the invention for supplying air to a fuel cell thus enables secure and reliable air supply to the fuel cell in the desired manner. Failure of components that are required for supplying air can be reduced to an absolute minimum.

In a particularly beneficial and advantageous refinement of the method according to the invention it is also provided that the specified value of the pressure and/or the pressure loss is corrected with measured influencing factors. Typically, various measured values from the air section of the fuel cell system are already available. Moreover, this applies also to other measured values from the fuel cell system such as, for example, temperatures and the like. All these values, which are measured anyway and are typically available in a control unit can now be used to appropriately correct the setpoint value of the pressure or the pressure loss so as to ensure that the measured value of the pressure or of the pressure loss for the desired air mass flow is controlled as exact as possible. Apart from such measured values, which have an influence on the air mass flow and can be used for the correction, other values which only indirectly influence the air mass flow can also be used after suitable model calculations for controlling so as to correct the setpoint value. Accordingly, it is provided in an advantageous refinement that the specified value of the pressure or of the pressure loss is corrected with further influencing factors which originate from model calculations. In these model calculations, all available measured values can be considered and, for example, inferences from the power to the air mass flow, from the hydrogen consumption to the air mass flow and the like can be calculated via a simulation. These values too can then be used for correcting the setpoint value of the pressure and/or of the pressure loss so as to further increase the accuracy of the adaptation of the pressure value to the air mass flow.

In a beneficial and advantageous refinement of the method according to the invention, the measured influencing factors for the direct correction and/or the measured values as a basis for the model calculation, which then also result in a correction of the setpoint values of the pressure and/or the pressure loss, can be based on one or more of the values listed below. Suitable values are in particular the ambient temperature, the temperature of the fuel cell and/or the temperature of the air mass flow. Also, the composition of the air mass flow, the operating state of the fuel cell and the current output of the fuel cell can be suitable basic variables. Likewise, the position of valve devices in the air section, humidification of the air mass flow or potential air losses caused by measured or known leakages can serve as a basis for the correction or the model calculation for the correction.

In an advantageous refinement it is also provided that the correction of the specified values is carried out via calculations and/or via characteristics maps via the correlation of the measured values or the values originating from the model calculation with the air mass flow. Hereby, the accuracy of the air supply to the fuel cell can be improved in a very simple and efficient manner.

In another very beneficial configuration of the method according to the invention it is also provided that in addition an air mass flow sensor is arranged in the air section, wherein depending on the operating of the fuel cell, the air-conveying device is adjusted to a specified value of the pressure, the pressure loss and/or the measured air mass flow. In this advantageous refinement of the method according to the invention, thus, an air mass flow sensor is used again in addition to the pressure sensor(s). Controlling can then be carried out based on an advantageous combination of the measured values of the air mass flow sensor and a pressure or pressure loss measurement. Thus, for example, controlling the pressure or pressure loss can be carried out in the region of air mass flows or in operating states of the fuel cell associated with said air mass flows in which, as is known, the accuracy of the air mass flow sensor is low. In other operating states of the fuel cell in which, as is known, the air mass flow sensor works well, said air mass flow sensor can be used. This applies in particular to operating states in which the measurement via the pressure or pressure loss alone is possibly difficult or inaccurate. Overall, the result is a very accurate control of the air supply across the entire load range or across all operating states of the fuel cell system. In particular, the control is more accurate and more reliable than the use of only one measuring principle, in particular when using only the air mass flow sensor.

In an advantageous refinement of this idea according to the invention, it is also possible that the air-conveying device is adjusted in each case to one of the values, wherein the respective other value/values serves/serve for the plausibility check of the control. This allows monitoring the control in terms of plausibility so as to be able, for example, to detect the failure of a sensor or the like in a simple and efficient manner. As already explained above, depending on the operating state of the fuel cell system, it can be particularly useful to sometimes use the one and sometimes the other measuring method. The respective other measuring method can then be used for checking plausibility of the control so that both implemented measuring methods can be used in normal operation of the fuel cell system.

The need of an air supply as good as possible with an air mass flow adapted as exact as possible to the requirements of the fuel cell is important in particular for fuel cell systems which are operated in a highly dynamic manner, thus with frequent changes in the output needed or air and hydrogen supply needed. Such systems are in particular used in vehicles. In vehicles there is typically a very dynamic demand for power output, in particular when the power is used at least partially as driving power for the vehicle. The preferred use of the method according to the invention for supplying air to a fuel cell therefore is the use for supplying air to a fuel cell in a fuel cell system which delivers electrical power, in particular electrical driving power for a vehicle. Such a vehicle can be, in particular, a trackless land vehicle but also a rail vehicle or a watercraft. The use of the fuel cell system for on-board power supply in an aircraft is also comprised by the definition of a fuel cell system which delivers electrical power for a vehicle.

Further advantageous configurations of the method according to the invention for supplying air to a fuel cell arise from the exemplary embodiments described hereinafter, which are described in greater detail hereinafter with reference to the figures.

In the figures:

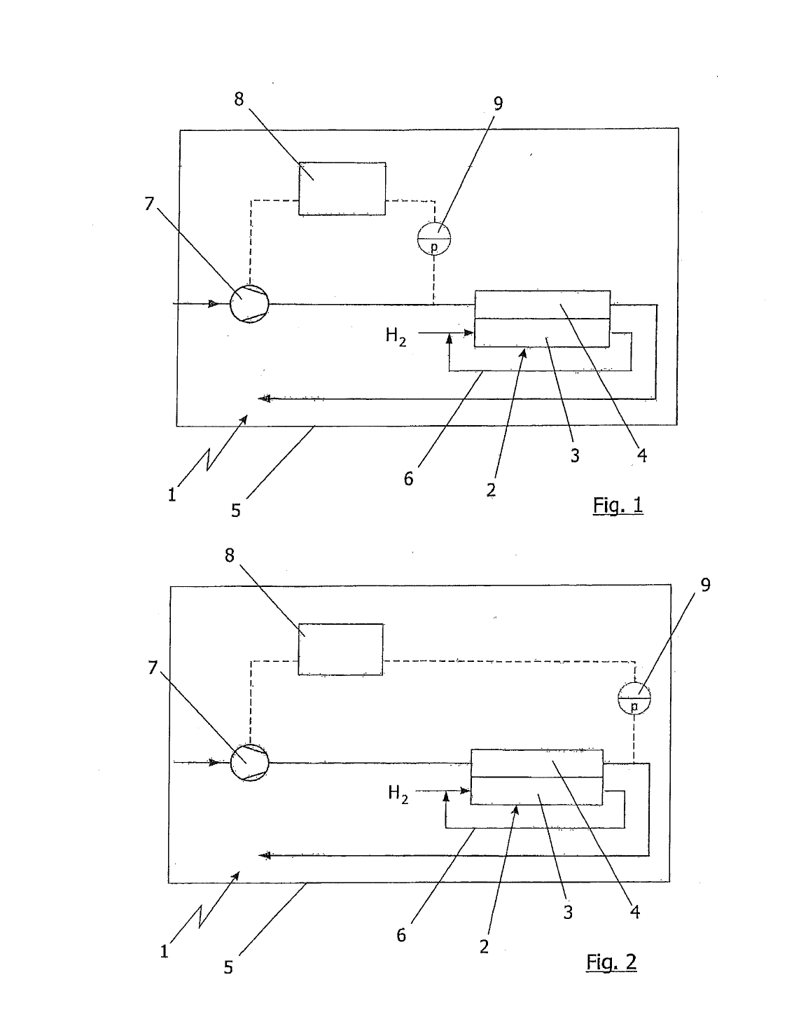

FIG. 1, shows a detail of a fuel cell system for carrying out the method in a first possible embodiment;

FIG. 2 shows a detail of a fuel cell system for carrying out the method in a second possible embodiment;

FIG. 3 shows a detail of a fuel cell system for carrying out the method in a third possible embodiment;

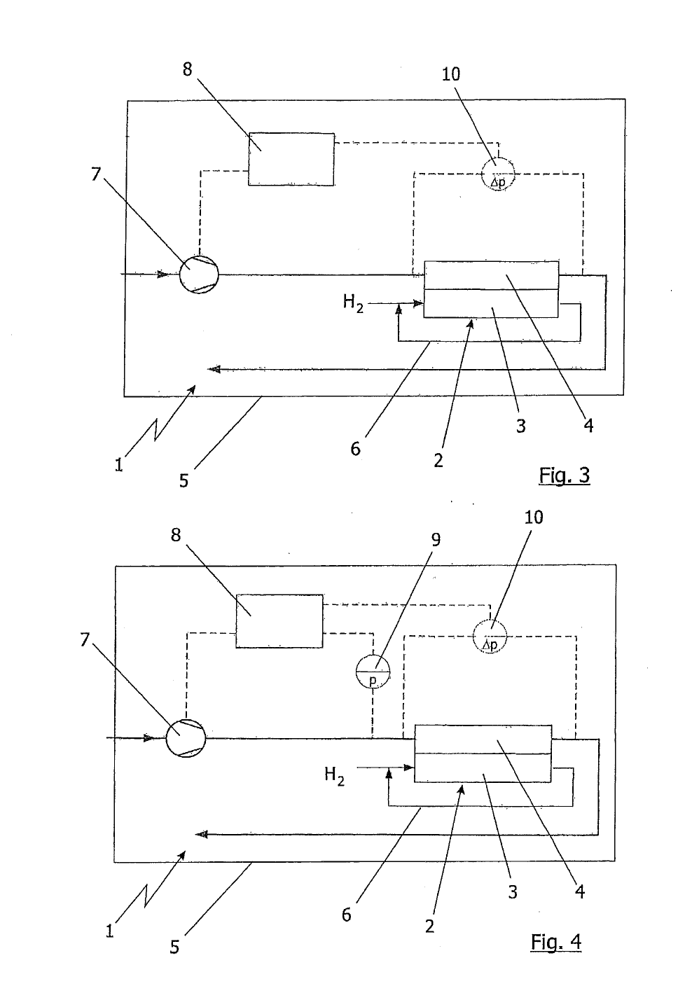

FIG. 4 shows a detail of a fuel cell system for carrying out the method in a fourth possible embodiment; and

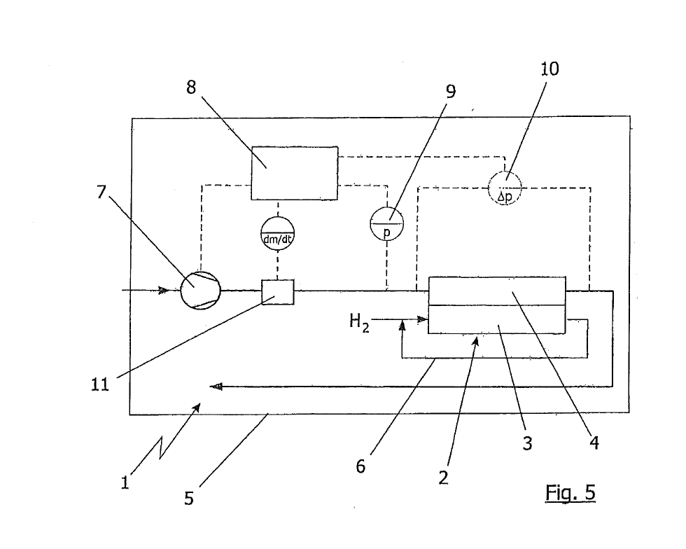

FIG. 5 shows a detail of a fuel cell system for carrying out the method in a fifth possible embodiment.

In the illustration of FIG. 1, a detail of the fuel cell system 1 can be seen, which detail is relevant for carrying out the method described hereinafter. The fuel cell system comprises substantially a fuel cell 2 which, for its part, has an anode chamber 3 and a cathode chamber 4. The fuel cell 2 itself is designed as a stack of PEM fuel cells. In the exemplary embodiment illustrated here, the fuel cell system 1 has to supply electrical driving power for a motor vehicle which is exemplary indicated by the box designated by 5. Since hydrogen supply to the anode chamber 3 of the fuel cell 2 does not play a significant role for the present invention, supply of hydrogen (H₂) is only indicated by way of example. Hydrogen can be fed, for example, in a circuit, designated by 6, around the anode chamber 3 of the fuel cell 2. Conventional components such as recirculation conveying devices, valves for discharging water and/or gases in the circuit 6 are not illustrated here, but can be integrated, of course.

The anode chamber 4 of the fuel cell 2 is supplied with air as an oxygen supplier via an air-conveying device 7. In order to ensure in all situations an ideal air supply or oxygen supply to the cathode chamber 4 of the fuel cell 2, the rotational speed of the air-conveying device 7 which, for example, can be designed as a flow compressor, is controlled in such a manner that the desired air mass flow or oxygen mass flow is available in the region of the cathode chamber 4. Controlling the air-conveying device 7 is carried out here by the control electronics 8. In the illustration of FIG. 1, the value of a pressure p, which—in the example illustrated here—is measured by a pressure sensor 9 in the air section upstream of the cathode chamber 4 of the fuel cell 2, serves as input variable for the control electronics 8. In the illustration of FIG. 2, an alternative position of the pressure sensor 9 in the air section, in this exemplary embodiment downstream of the cathode chamber 4 of the fuel cell 2, is indicated. Such a position of the pressure sensor 9 is also possible and conceivable. As an alternative to measuring a value of the pressure p in the air section, it is also possible to measure a pressure loss Δp. This is illustrated in FIG. 3 in an analogous exemplary embodiment. The value of the pressure loss Δp can be measured—as illustrated—via a pressure loss sensor 10 or via two pressure sensors. Based on the pressure p or the pressure loss Δp, the air-conveying device 7 can be controlled via the control electronics 8 so as to be adapted extremely well to the requirements of the fuel cell 2. Of course, a combination of both alternatives is also conceivable. This is shown in the illustration of FIG. 4. In this construction, failure of one of the sensors 9, 10 can be compensated.

Thus, in the exemplary embodiments illustrated here, the air-conveying device 7 is adjusted in a closed loop control circuit to a predetermined value (setpoint value) of the pressure pₛₒₗₗ and/or of the pressure loss Δpₛₒₗₗ without requiring an air mass flow sensor. This means that the rotational speed of the air-conveying device 7 is changed via the control electronics 8 in such a manner that the measured values of the pressure p and/or the pressure loss Δp adjust themselves to the specified values of the pressure pₛₒₗₗ and/or the pressure loss Δpₛₒₗₗ. This results already in good air supply to the fuel cell 2 with the air masses or oxygen mass flow needed in the respective conditions of the fuel cell 2. The quality of the control of air supply to the fuel cell 2 can be further increased by correcting the specified value of the pressure pₛₒₗₗ and/or the pressure loss Δpₛₒₗₗ, thus the pressure setpoint value and/or the pressure loss setpoint value for the control, with further influencing factors. Such a correction can take place, for example, via calculations and/or characteristics maps which are stored in the control electronics 8. In particular, all values of the fuel cell system 1 which are already measured and which have a direct or indirect influence on the air mass flow can be considered. Here, the influencing factors can be measured directly. It is also conceivable to derive or calculate the influencing factors from other measured values via model calculations such as a simulation calculation or the like. The correction can have a rather basic character here so that, for example, a correction is carried out in dependence on values that are valid long-term, or it can be carried out immediately in that at each individual point in time, the setpoint values for the pressure pₛₒₗₗ or the pressure loss Δp are adjusted with high temporal solution. Conceivable influencing variables and measured values which can be converted indirectly via model calculations into influencing variables can be the following, for example:
Ambient temperature,
temperature of the fuel cell 2,
temperature of the air upstream and/or downstream of the air-conveying device 7,
composition of the air mass flow
operating state of the fuel cell 2,
current power output of the fuel cell 2
position of valve devices of the air section,
humidification of the air, and/or
losses through leakages in the air section.

Thus, without requiring a complicated, expensive air mass flow sensor that is very susceptible to failure specifically when used in fuel cell systems 1, it is possible with the method to implement a very exact control of air supply to the fuel cell 2 in a very efficient manner and without the need of additional sensors since the needed sensors typically are already provided.

Another alternative construction for the method is shown in the illustration of FIG. 5. FIG. 5 corresponds largely to the construction illustrated in FIG. 4. In addition, an air mass flow sensor 11 is positioned in the air section. This air mass flow sensor 11, which is arranged in the fuel cell system 1 in addition to the pressure sensors 9 and 10, can be used for further improvement of the control of the air supply. This air mass flow sensor is illustrated here in the exemplary embodiment according to FIG. 4, thus with the sensor 9 for detecting the pressure p and the sensor 10 for detecting the pressure loss Δp. Likewise, adding the air mass flow sensor 11 to the other illustrated exemplary embodiments according to FIGS. 1 to 3 would also be conceivable and possible.

In this embodiment of the method, controlling the air mass flow can be carried out based on an advantageous combination of the measured values of the air mass flow sensor 11 and the sensors 9 and/or 10. For example, in the region of air mass flows or operating states of the fuel cell 2 in which, as is known, the accuracy of the air mass flow sensor 11 is low, the air supply can be adjusted to the specified setpoint value of the pressure pₛₒₗₗ or the pressure loss Δpₛₒₗₗ. However, in other operating states of the fuel cell 2, the air mass flow sensor 11 can be used instead for controlling For this, the air mass flow dm/dt currently measured by the air mass flow sensor 11 is adjusted to the specified required setpoint value of the air mass flow dmₛₒₗₗ/dt. This particularly advantageous variant results in a control of the air mass flow that is very accurate across the entire load range or across all operating states of the fuel cell 2.

Moreover, with this construction it is principally conceivable, in particular depending on the operating state of the fuel cell 2, to control either the air mass flow dm/dt or the pressure value p or pressure loss Δp. The respective other measured value or values can then be used for checking plausibility or for monitoring that measured value that is controlled. This minimizes the system's susceptibility to failure and a very secure and reliable control of air supply to the fuel cell 2 is achieved. In the case of a detected malfunction, the control can also be changed over to the other measured value.

1. A method for supplying air to a fuel cell (2) by means of a controllable air-conveying device that delivers an air mass flow for a cathode chamber (4) to the fuel cell (2), wherein the air-conveying device (7) is adjusted to a specified value of a pressure (pₛₒₗₗ) in the air line and/or to a specified value of a pressure loss (Δpₛₒₗₗ) across a component of the air line.

2. The method according to claim 1 wherein the actual value of the pressure loss (Δp) is measured across a component of the air line.

3. The method according to claim 1, wherein the actual value of the pressure loss (Δp) is measured across the cathode chamber (4) as the component.

4. The method according to claim 1, wherein the actual value of the pressure (p) is measured upstream of the cathode chamber (4).

5. The method according to claim 1, wherein the specified value of the pressure (pₛₒₗₗ) and/or of the pressure loss (Δpₛₒₗₗ) is corrected with measured influencing factors.

6. The method according to claim 1, wherein the specified value of the pressure (pₛₒₗₗ) or of the pressure loss (Δpₛₒₗₗ) is corrected with further influencing factors which are determined via model calculations.

7. The method according to claim 6, wherein the model calculations are carried out based on measured values.

8. The method according to claim 5, wherein the measured influencing factors and/or the measured values comprise at least one of the following variables:
ambient temperature,
temperature of the fuel cell (2),
temperature of the air upstream and/or downstream of the air-conveying device (7),
composition of the air mass flow,
operating state of the fuel cell (2),
current power output of the fuel cell (2),
position of valve devices of the air line,
humidity of the air, and/or
losses through leakages in the air line.

9. The method according to to claim 5, wherein the correction of the set or target or specified values of the pressure (pₛₒₗₗ) and/or the pressure loss (Δpₛₒₗₗ) is carried out via calculations and/or characteristics maps.

10. The method according to to claim 1, wherein in addition an air mass flow sensor (11) is arranged in the air line, wherein depending on the operating state of the fuel cell (2), the air-conveying device (7) is adjusted to a set or target or specified value of the pressure (pₛₒₗₗ), the pressure loss (Δpₛₒₗₗ) and/or an air mass flow (dmₛₒₗₗ/dt).

11. The method according to claim 10, wherein the air-conveying device (7) is adjusted in each case to one of the values, wherein the respective other value/s is/are used for checking plausibility of the control.

12. A method as in claim 1, wherein the air is supplied to a fuel cell (2) in a fuel cell system (1) which delivers electrical power for a vehicle (5).

13. A method as in claim 12, wherein the electrical power is at least partially used as driving power for a vehicle (5).
